(19) United States
(12) Patent Application Publication
(10) Pub. No.: US 2017/0132299 A1
(43) Pub. Date: May 11, 2017

(54) SYSTEM AND METHOD FOR MANAGING DATA ASSOCIATED WITH WORKSITE

(71) Applicant: Caterpillar Inc., Peoria, IL (US)

(72) Inventors: Sharon L. Fox, Brisbane (AU); Kerry N. Bennett, Brisbane (AU); Gordon W. Mountford, Brisbane (AU)

(73) Assignee: CATERPILLAR INC., Peoria, IL (US)

(21) Appl. No.: 14/936,955

(22) Filed: Nov. 10, 2015

(51) Int. Cl. G06F 17/30

(52) U.S. Cl. CPC G06F 17/30563; G06F 17/30592

(57) ABSTRACT

A system for managing data associated with one or more worksites is provided. The system includes one or more source systems associated with the one or more worksites for receiving the data associated with the one or more worksites. The system further includes an information accessing system in communication with the one or more source systems. The information accessing system includes a data management system, a deployment and packaging module, and a corporate warehouse. The data management system includes a data capturing module, a data virtualization module, and a data warehouse. The data virtualization module includes a data identification module, a standardization module, a transformation module, and a data consolidation module.

### TECHNICAL FIELD

The present disclosure relates to a data management system, and more particularly related to a system and a method for managing data associated with worksites.

### BACKGROUND

Generally, various operations at a particular worksite are stored at source systems. The source systems include databases for storing data corresponding to each of the various operations. The data stored in the databases is accessed for generating reports. The reports are used for analyzing the various operations at the worksite. The databases of the source systems are not designed for relational reporting, hence, they are complex and hard to use. Conventional systems utilize specific reporting tools for each of the source systems. Hence, user should have knowledge for using each of the specific reporting tools. Also, the databases are not specially designed for generating reports. Besides, the databases include all information about the worksite. These increase complexity of report generation process. Further, a comparison of performances between various worksites is complex, as an interconnection between the source systems is unavailable. Moreover, the user may find difficulties for generating a consolidated report related to various operations of the worksite from different source systems, as format of data stored in each of the source systems is different. Multiple source systems have different formats for a business function, for example a machine. So the same methodology of report generation cannot be used across the multiple source systems, which in turn confuse the user and often requires different reporting tools. Further, a system used for generating reports establishes data warehouses for storing data related to the worksite. The stored data in the data warehouse may be exclusively used for generating the reports. However, the update of source systems may break the data warehouse, since the data warehouse is defined based on the data from the source systems.

US Patent Publication Number 2002/0107873 discloses a system for providing centralized management and analysis of fleet information. The system includes a centralized fleet information management server accessible via a communications network to thin clients. The communications network may be Internet, and the thin clients are required to have only a web browser application to fully access functionality of the server. A portable computing device, such as a Windows CE or Palm compatible device is used with an installed application program to conduct on-site and off-line inspections. The portable device includes a local source table that is populated with fleet information downloaded from the fleet information management server. Upon completion of on-site inspection, data stored in the local source table is uploaded to the server. The server is used by thin clients to generate various reports based on the fleet data, including estimation of operating cost savings.

### SUMMARY OF THE DISCLOSURE

In one aspect of the present disclosure, a system for managing data associated with one or more worksites is provided. The system includes one or more source systems associated with the one or more worksites for receiving the data associated with the one or more worksites. The system further includes an information accessing system in communication with the one or more source systems. The information accessing system includes a data management system, a deployment and packaging module, and a corporate warehouse. The data management system includes a data capturing module, a data virtualization module, and a data warehouse. The data virtualization module includes a data identification module, a standardization module, a transformation module, and a data consolidation module.

In another aspect of the present disclosure managing data associated with one or more worksites is provided. The method includes receiving the data associated with the one or more worksites by one or more source systems. The method further includes accessing the data received in the one or more source systems using an information accessing system. The method of accessing the data includes extracting the data from the one or more source systems. The method of accessing the data further includes formatting the extracted data by a data virtualization module. The method of accessing the data includes storing the consolidated data in a data warehouse.

In yet another aspect of the present disclosure, a computer program product embodied in a computer for managing data associated with one or more worksites is provided. The computer program product causing the computer to perform operations includes receiving the data associated with the one or more worksites by one or more source systems. The operation further includes accessing the data received in the one or more source systems using an information accessing system. The operation of accessing the data includes extracting the data from the one or more source systems. The operation of accessing the data further includes formatting the extracted data by a data virtualization module. The operation of accessing the data includes storing the consolidated data in a data warehouse.

Other features and aspects of this disclosure will be apparent from the following description and the accompanying drawings.

### BRIEF DESCRIPTION OF THE DRAWINGS

FIG. 1 is a schematic block diagram showing worksites and one or more source systems associated with the worksites in an exemplary environment, according to an embodiment of the present disclosure;

FIG. 2 is a block diagram of a system having an information accessing system for managing data associated with the worksites, according to an embodiment of the present disclosure;

FIG. 3 is a block diagram of a data management system of the information accessing system, according to an embodiment of the present disclosure;

FIG. 4 is a block diagram of a data warehouse of the data management system, according to an embodiment of the present disclosure; and

FIG. 5 is a block diagram of a deployment packaging module of the information accessing system, according to an embodiment of the present disclosure;

FIG. 6 is a schematic representation of a corporate warehouse of the information accessing system, according to an embodiment of the present disclosure;

FIG. 7 is a block diagram of a corporate warehouse for generating multisite comparison reports, according to an embodiment of the present disclosure;

FIG. 8 is an time usage model present in reporting server of the system, according to an embodiment of the present disclosure; and

FIG. 9 is a flowchart of a method of managing data associated with the worksites, according to an embodiment of the present disclosure.

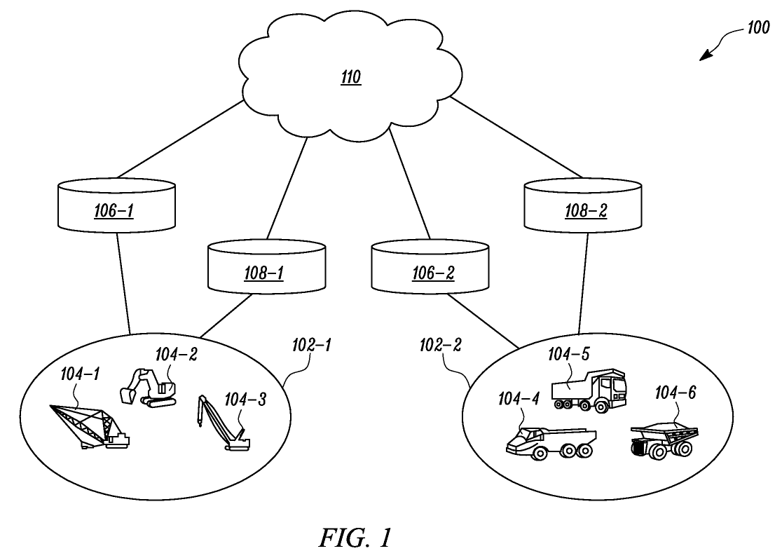

### DETAILED DESCRIPTION

Wherever possible, the same reference numbers will be used throughout the drawings to refer to the same or the like parts. FIG. 1 illustrates an exemplary environment 100 having a first worksite 102-1 and a second worksite 102-2 (collectively referred to as “the worksites 102”) and a plurality of machines 104-1, 104-2, 104-3, 104-4, 104-5 and 105-5 (collectively referred to as “the machines 104”) working in the first and second worksites 102-1, 102-2. It may also be contemplated that the environment 100 may include one worksite 102 and one machine 104 operating thereon for performing various earth moving operations. The machines 104 may be deployed on the worksites 102 and configured for performing one or more operations such as, transportation of material from one location to another. The machines 104 may be, for example, mining trucks, haul trucks, on-highway trucks, off-highway trucks, articulated trucks, and the like. Further, a number of different loading machines may be deployed in the worksites 102. The loading machine is configured to load the material onto other machines on the worksites 102. The loading machines may include, for example, conveyors, wheel loaders, track-type loaders, shovels, draglines, cranes and the like. The machines 104 deployed on the worksites 102 may also include manned machines, autonomous machines and/or semi-autonomous machines.

Each of the worksites 102 is communicated with multiple source systems 106, 108. For example, the first worksite 102-1 is communicated with a first source system 106-1 and a second source system 108-1. Similarly, the second worksite 102-2 is communicated with a first source system 106-2 and a second source system 108-2. The first source systems 106-1 and 106-2 and the second source systems 108-1 and 108-2 are hereinafter referred to as ‘the first source system 106’, and ‘the second source system 108’, respectively. The first and second source systems 106, 108 may be worksite management systems. The first and second source systems 106, 108 may include database. The first and second source systems 106, 108 may collect data related to the machines 104, information related to the worksites 102 on which the machines 104 operate, personnel information related to crew or designated work staff operating the machines 104, or a combination thereof. Accordingly, database of the first and second source systems 106, 108 may include machine information, worksite information, personnel information, or a combination thereof.

Although, only the first and second source systems 106, 108 are described with reference to the worksites 102, the environment 100 may include any number of source systems, based on type of applications. For example, the environment 100 may include at least one of a terrain management system, a fleet management system, a machine detection system, an autonomous machine control system, a semi-autonomous machine control system, a reporting system associated with fleet management applications, an integrated machine control system, a machine health monitoring system, a command system, and so on. It may be understood that the first and second source systems 106, 108 disclosed in the present disclosure may be distinct from each other with respect to architecture, data storage capabilities, type of data stored therein, data formats, and have distinct system implementation and functionality.

The first and second source systems 106, 108 may be communicated via a network 110. Examples of the network 110 may include, but are not limited to, a wide area network (WAN), a local area network (LAN), an ethernet, an internet, an intranet, a cellular network, a satellite network, or any other known network for transmitting and receiving data. In various embodiments, the network 110 may include a combination of two or more of the aforementioned networks and/or other types of networks known in the art. Further, the network 110 may be implemented as a wired network, a wireless network, or a combination thereof. Further, data transmission may take place over the network 110 with a network protocol such that data transmission may be in an encrypted format or any other secure format, or in any of wide varieties of known manners.

In the present embodiment, the first source system 106 may embody a terrain management system. The first source system 106 may store and process data related to a terrain of the worksites 102 on which the machines 104 operate. The first source system 106 may be configured to store and maintain surface data associated with the worksites 102. The term “surface data” used herein refers to terrain information and other parameters associated with the worksites 102. For example, the surface data may include, but not limited to, an elevation, object detection, radio network signal strength, and other geospatial aspects of the worksites 102.

In one embodiment, based on the surface data, a surface model of the worksites 102 may be generated and stored in the first source system 106, using any known technique in the art. Further, the source table of the first source system 106 may be configured to store an updated surface data, wherein the updated surface data includes a latest or updated version of the surface data associated with the worksite 102. Different levels of granularity or resolution of the surface data may also be maintained within the source table of the first source system 106. The source table of the first source system 106 may further store a digital map indicative of compaction of the worksites 102 as a function of history of travel of one or more machines across the worksites 102.

The second source system 108 may embody a fleet management system. The second source system 108 may be associated with information related to the machines 104 operating on the worksites 102, and may be used for asset management and for providing an interface for controlling or accessing information related to an operation of a fleet of the machines from a remote location. For example, the machines 104 are equipped with a number of sensors for detecting various machine parameters, positioning of the machines 104 on the worksites 102, and other characteristic data during working of the machines 104. The second source system 108 may involve gathering data regarding the fleet, managing and interpreting machine maintenance parameters such as understanding how and when to perform maintenance in a machine, i.e., perform preventative maintenance, and coordinating all of the activity surrounding or going into the maintenance of the machines 104. The second source system 108 may be an open fleet management system and/or an underground fleet management system.

The second source system 108 may further store information regarding location and direction of movement of each of the machines 104 in the fleet as well as status of predetermined events in which the machines 104 are engaged. In one embodiment, the machines 104 are equipped with a plurality of sensors for detecting information regarding characteristics of the machines 104 itself, for example, speed, steering angle, orientation such as pitch and roll, geographical location, load, and load distribution. The second source system 108 may include various modules for monitoring, recording, conditioning, storing, indexing, processing, and/or communicating information received from the plurality of sensors associated with the machines 104.

The first and second source systems 106, 108 communicated with the first and second worksites 102-1, 102-2, respectively, are exemplary and should not limit the scope of the present disclosure. The functionality of the first and second source systems 106, 108 described herein is also exemplary. The first and second source systems 106, 108 may additionally include other components and capabilities not described herein. The environment 100 may additionally include any number of source systems. Further, architecture and capabilities of the first and second source systems 106, 108 may vary without any limitation.

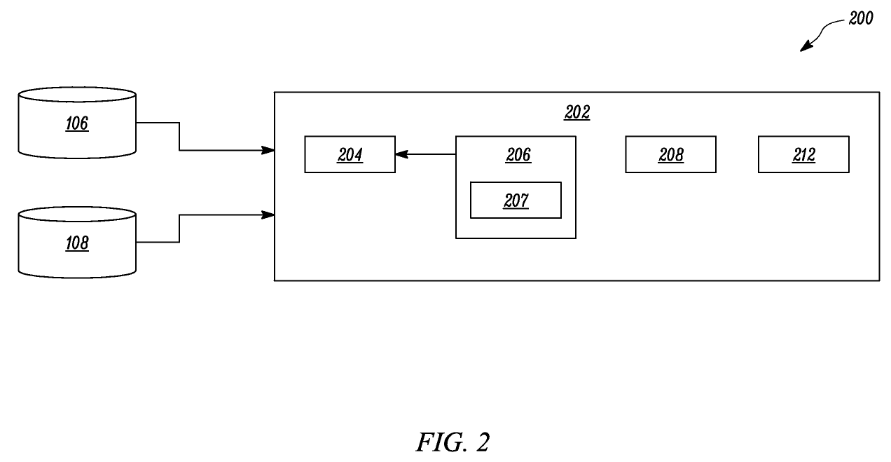

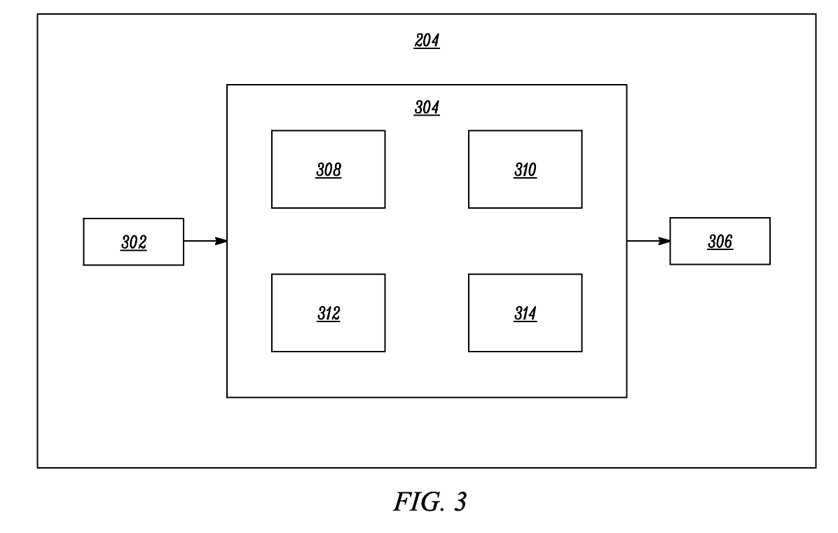

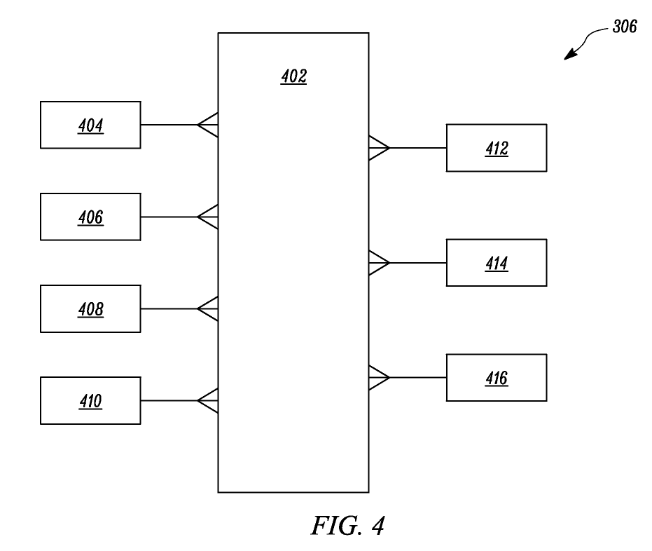

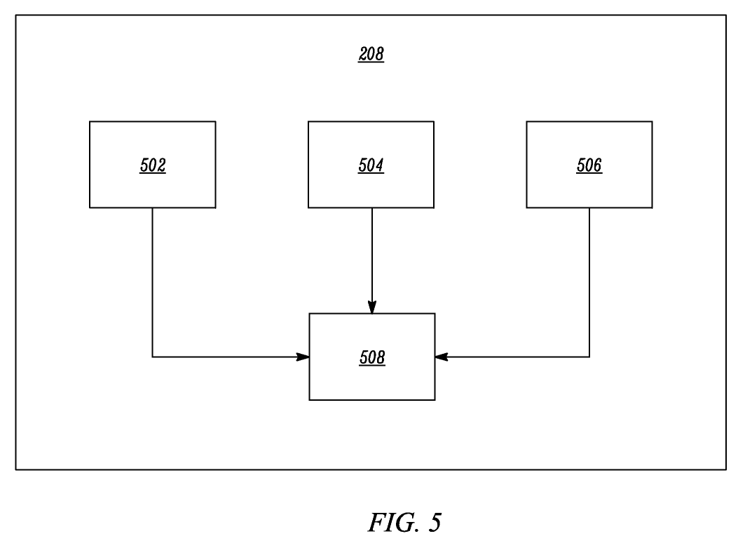

FIG. 2 illustrates a block diagram of a system 200 for managing data associated with the worksites 102. The system 200 used for managing the data includes the first and second source systems 106, 108. The first and second source systems 106, 108 receive data from the worksites 102 and stored in corresponding databases (not shown). The first and second source systems 106, 108 are communicated to an information accessing system 202. The information accessing system 202 provides an access of the data received from the first and second source systems 106, 108. The information accessing system 202 includes a data management system 204. The data management system 204 is configured to extract and store the data from the first and second source systems 106, 108. The data management system 204 is described in detail with reference to FIG. 3. The data management system 204 is communicated with a reporting server 206. The reporting server 206 is configured to generate reports in respect of the worksites 102 based on the data stored in the data management system 204. The information accessing system 202 further includes a deployment packaging module 208 communicably coupled with the data management system 204. The deployment packaging module 208 is configured to deploy the data management system 204 in the system 200 for managing the data associated with the worksites 102. The deployment packaging module 208 is described in detail with reference to FIG. 4. The information accessing system 202 further includes a corporate warehouse 212 connected to the data management system 204. The information accessing system 202 is described in detail with reference to FIG. 5.

In an embodiment, the system 200 may be implemented as a web-based application. For example, the system 200 may be a cloud implemented platform hosted in one or more servers accessible to the users over the network 110, such as the internet. Further, the system 200 may be configured to generate an output, such as a user interface for display to the user.

Referring to FIG. 3, a block diagram of the data management system 204 is illustrated. The data management system 204 includes a data capturing module 302. The data capturing module 302 is communicated with the first and second source systems 106, 108. The data management system 204 further includes a data virtualization module 304 communicably connected with the data capturing module 302. The data virtualization module 304 is communicated with a data warehouse 306.

The data in respect of the worksites 102 is collected and stored at the database corresponding to the first and second source systems 106, 108. The data capturing module 302 is configured to extract the data from the databases of the first and second source systems 106, 108. In one example, the data extracted from the first source system 106 may include historic data, model data and summaries in respect of the worksites 102. Similarly, the second source system 108 may include data such as grading and loading data, data of drills, and data of draglines. In another example, the extracted data includes production information, machine information, operator information, and machine time line data, production recording data, a set of pre-defined rules, a plurality of pre-defined parameters, and a combination thereof. The plurality of pre-defined parameters may include at least one of time data, location of the worksites 102, and materials used at the worksites 102. The machine time line data includes at least one of an activity event at the worksites 102, delays at the worksites 102, and a combination thereof. The extracted data further includes one or more commands for hauling fleet for underground, design standards and dimensions corresponding to the worksite 102 collected from the first and second source systems 106, 108. It may be contemplated that the data capturing module 302 may extract data from any other source systems based on system requirements. The extracted data may have different categories with different format such as machines, location information, reporting periods, cycle shifts, time usage and the likes.

The data extracted by the data capturing module 302 is transferred to the data virtualization module 304. The data virtualization module 304 is configured to integrate the data captured from the first and second source systems 106, 108. The data virtualization module 304 includes a data identification module 308. The data identification module 308 is configured for identifying a format of the extracted data. The first and second source systems 106, 108 may be deployed in different development platforms and operating systems. Also, there may be different versions of the first and second source systems 106, 108. In one example, the second source system 108 may be fleet management system of version 4.0.7. Whereas, another second source system 108 may be fleet management system of version 4. 3. Hence, the data extracted from the first and second source systems 106, 108 may have different formats. Furthermore, the format of the extracted data may depend on type of database of the first and second source systems 106, 108. For example, the database of the first and second source systems 106, 108 may be deployed in different servers, such as Oracle and SQL server. Moreover, the format of the extracted data may depend on a reporting tool 207.

The data identification module 308 is communicated with a standardization module 310. The standardization module 310 is configured to determine a plurality of pre-defined standards associated with the extracted data. The pre-defined standards may include units of extracted data, time associated with one or more actions performed at the worksites 102. The standardization module 310 is communicated with a transformation module 312. The transformation module 312 is configured for transforming the identified format of the extracted data based on the plurality of pre-defined standards. The transformation module 312 includes one or more transformation logics. In one example, the transformation module 312 includes an extraction transformation and load (ETL) logic. The transformation module 312 is configured to define a common format for the extracted data. The common format is defined based on the data warehouse 306. Further, the format of the extracted data is converted into the defined common format based on the pre-defined standards.

The transformation module 312 is communicated with a data consolidation module 314. The data consolidation module 314 is configured for consolidating the data transformed by the transformation module 312. The extracted data may have different attributes such as naming standards, time, reporting periods, cycles, shifts, time usage corresponding to the first and second source systems 106, 108 from which the data is extracted.

Also, production data has different levels of aggregation in the first and second source systems 106, 108, such as cycle, activity, shifts, and reporting periods. For example, the first and second source systems 106,108 may describe a work performed at the worksites 102 by different levels of detail.

In one example, the machine 104 deployed at the worksites 102 may be a truck. The worksite 102 may be connected to the first source system 106. One or more activities of the truck may be fetched and stored at the first source system 106. The one or more activities related to the truck may be defined as a truck cycle. The truck cycle may include activities such as travelling empty, queueing, loading, travelling full, and dumping. In an example, an average time for one truck cycle may be defined as 30 minuets. In another example, the machine 104 deployed in the worksites 102 may be a dozer. The worksite 102 is communicated with second source system 108. One or more activities of the truck may be fetched and stored at the second source system 106. One or more activities performed by the dozer may be referred as a dozer cycle. The dozer cycle may include forward and backward movement of a ground moving tool of the dozer. This includes hundreds of dozer cycles in 30 minutes. In such scenarios of multiple time zones and reporting periods, the data consolidation module 314 is configured to consolidate the extracted data to a standardized representation.

The data consolidation module 314 breaks the cycles and activities into a parametrized duration, for example, 30 minute time period. This allows multiple definitions of shifts and reporting periods to be aggregated by a standard calendar. Further, custom shifts are introduced in the reporting periods. The data management system 204 is enabled to provide a graphical user interface (not shown). The graphical user interface presents the data in a user understandable format. This prevents the user error while consolidating data. The data consolidation module 314 is configured to scale the data associated with the worksites 102 such as truck production, loader production, fleet utilization and fleet Ton Kilometer per Hour (TKPH) to other products such as drills, dozers, and draglines.

The data virtualization module 304 is connected to the data warehouse 306. The data warehouse 306 stores the consolidated data for reporting and analyzing purposes. The data warehouse 306 may contain specifically structured collection of data. The data stored in the data warehouse 306 may be subject-oriented, integrated, time-variant and non-volatile. In one embodiment, an outcome of the data consolidation module 314 is stored in the data warehouse 306. An exemplary architecture of the data warehouse 306 is illustrated in FIG. 4.

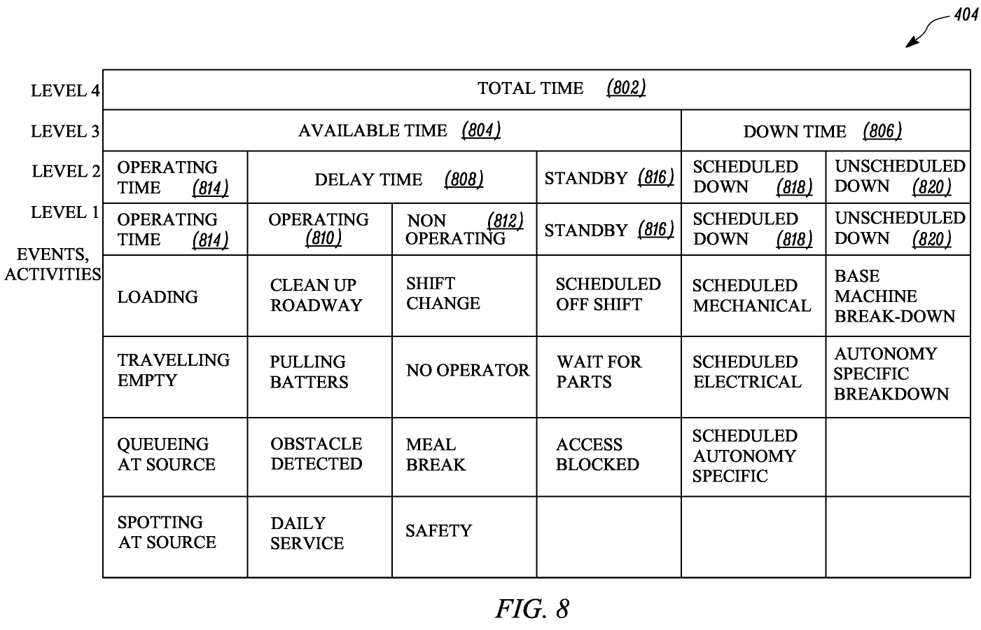

Referring to FIG. 4, a schematic representation of the data warehouse 306 is illustrated. The data warehouse 306 may include a fact table 402. The fact table 402 may correspond to any parameter associated with the worksites 102. The parameters of the fact table 402 may include fleet TKPH, fleet utilization, loader production, truck production and the likes. The data warehouse 306 further includes multiple dimension tables. The plurality of dimension tables includes various attributes of the parameters present in the fact table 402. In one embodiment, at least one of the multiple dimension tables may be a time usage model 404. The time usage model 404 is configured to generate time reports of the one or more worksite 102. The time usage model 404 is illustrated in detail with reference to FIG. 8. The time usage model 404 enables tracking of various time attributes of a worksite including, but not limited to, total time, available time, operating time, standby and the likes. The time usage model 404 is defined based on a hierarchy of activities performed at the worksites 102. The time captured in a lower level component may be equal to the time captured in a higher level component of the hierarchy. A higher level includes a delay category. Activities and delays in respect of the machine 104 are the lowest level in the time usage model 404. A lower level component may be mapped to one machine higher level.

The time usage model 404 may be created based on a specification of the worksites 102. The specification of the worksite 102 may include nature of the worksites 102, machines 104 implemented in the worksites 102, and the likes. The hierarchy may be defined in the time usage model 404 by defining multiple levels for different activities and time delays are aggregated and/or reported in the worksites 102. Further, the activities and time delay events may be mapped into one lowest level event associated with the worksites 102. For an example, the lowest level event may include, but not limited to, loading time, clean up roadway, shift change, and base machine break down. The time usage model 404 may include, but not limited to, worksite level time usage model, operator level time usage model and the likes. Multiple time usage models may be deployed in the data warehouse 306. Whereas only one time usage model may be active at a time.

In an example, the fact table 402 may correspond to a fleet utilization. The dimension tables further include various attributes related to the fleet utilization. The attributes may include, but not limited to, a calendar 406, a time information 408, a site information 410, a machine information 412, an operator information 414, and an event information 416. The details of the attributes are stored in the corresponding dimension table. The contents of the fact table 402 and the dimension tables are obtained from the extracted data from first and second source systems 106, 108. The data warehouse 306 is connected to the reporting server 206. The reporting server 206 is enabled to generate one or more reports in respect of the worksites 102 based on the data stored in the data warehouse 306.

The reporting server 206 of the information accessing system 202, as shown in FIG. 2, is configured to access the data stored in the data warehouse 306. The reporting server 206 includes the reporting tool 207. The reporting tool 207 is communicated to the data warehouse 306. The reporting tool 207 may be embodied as a query tool that allows the user to query the data warehouse 306 and obtain required information therefrom.

The reporting tool 207 may include any report generating software module known in the art. The reporting tool 207 may facilitate interaction with the data warehouse 306 via a graphic user interface or any other interface known in the art that may be used to query the data warehouse 306 and obtain reports therefrom. These reports may be provided to the user in any format, for example, spreadsheets, maps, charts, graphs, datasheet, statistic curves, data models, diagrams, tables, pictorial representations, or any other graphical or textual output generated by the reporting tool 207 that may be known in the art.

FIG. 5 illustrates a block diagram of the deployment packaging module 208. The deployment packaging module 208 includes a source system support module 502. The source system support module 502 is configured to provide a plurality of pre-defined supporting instructions for deployment of the data management system 204. The plurality of the pre-defined supporting instructions may include aids for deployment of the data management system 204. The deployment packaging module 208 includes a configuration module 504. The configuration module 504 is enabled to configure the data management system 204 using the plurality of pre-defined supporting instructions. The configuration module 504 may include information corresponding to the first and second source systems 106, 108 and frequency of implementation of ETL logic. The deployment packaging module 208 further includes a scheduling module 506. The scheduling module 506 is configured to schedule a set of pre-defined transformation logic to be executed during the configuration of the data management system 204. The deployment packaging module 208 further includes a schema 508 of the data management system to be deployed and/or updated.

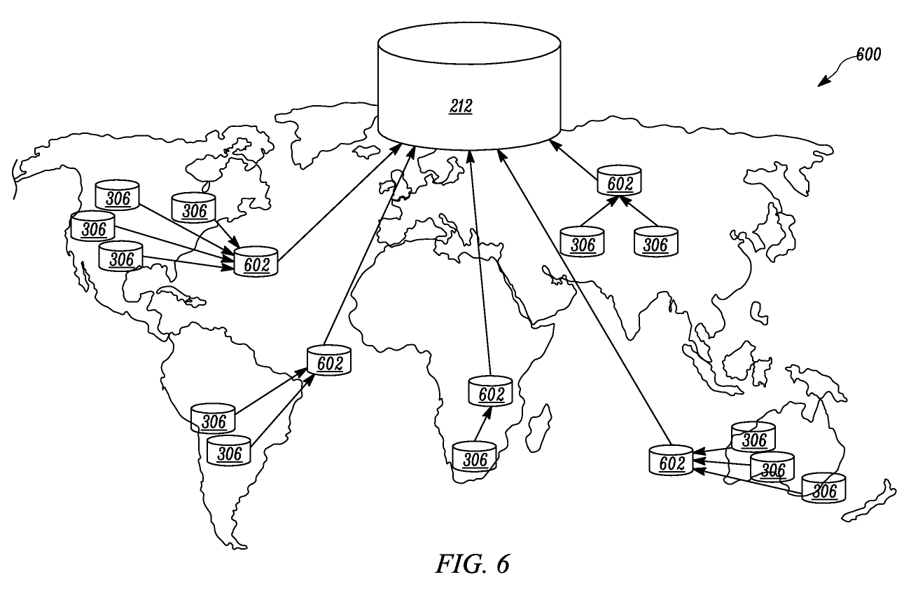

FIG. 6 illustrates a schematic representation of the corporate warehouse 212. The corporate warehouse 212 is configured to aggregate data from the worksites 102 located at multiple locations. In order to procure data from the data warehouse 306 located at the multiple locations, the corporate warehouse 212 requires a multi site enabled schema design, a multi site deployment packaging module, and a multi site configuration module. The corporate warehouse 212 is further configured to retrieve data stored in the data warehouse 306 located at the multiple locations and/or directly from the data bases of first and second source systems 106, 108. The database of each of the first and second source systems 106, 108 and data warehouse 306 of corresponding to each of the worksites 102 may have different definitions for measurement units of various parameters such as, but not limited to, materials, time, work cycle, calendar and the like. The corporate warehouse 212 is further configured to analyze data from the data warehouse 306 and data bases of the first and second source systems 106, 108. The corporate warehouse 212 is further configured to generate one or more reports based on the data received from the data warehouse 306 located at each of the worksites 102.

A schematic block diagram of a corporate warehouse 212 is illustrated in FIG. 6. The data from the data warehouses 306 located at each of the worksites 102 is collected to a regional warehouse 602. For example, the data stored in the data warehouse 306 of one or more worksites of a particular location are collected to the regional warehouse 602. The regional warehouse 602 at each of different locations is communicated to the corporate warehouse 212.

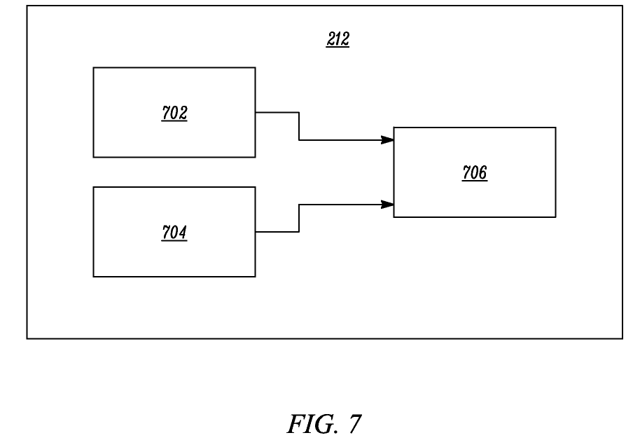

Referring to FIG. 7, a block diagram of the corporate warehouse 212 for generating multisite comparison reports is illustrated. The corporate warehouse 212 includes a comparison module 702. The comparison module 702 is configured to generate multisite comparison report. The multisite comparison report includes reports of one or more worksite 102 at one or more locations. Further, the multisite comparison report includes comparison results of one or more parameters of the worksites 102 such as, but not limited to, efficiency, performance, production, cost and the likes. The corporate warehouse 212 includes a report generation module 704. The report generation module 704 includes one or more third party reporting tools. The third party reporting tools may be configured to generate one or more dynamic reports of the data warehouses 306 of the first and second source systems 106, 108 of the one or more worksites 102. The corporate warehouse 212 further includes a storage module 706. The storage module 706 is configured to store the multisite comparison reports and the report generated using the one or more third party reporting tools. The reports generated and stored at the corporate warehouses 212 may be accessed using one or more mobile devices.

It may be contemplated that the information accessing system 202, the data management system 204, the data capturing module 302, the data virtualization module 304, the deployment packaging module 208, the data identification module 308, the standardization module 310, the transformation module 312, the data consolidation module 314, the source system support module 502, the configuration module 504, the scheduling module 506, the comparison module 702, the report generation module 704, and the storage module 706 described herein are exemplary. The functionalities performed by each of the information accessing system 202 and the aforementioned modules may be performed in combination without any limitation. Further, additional functionalities may be performed the information accessing system 202 and any of the aforementioned modules.

The time usage model 404 illustrated in FIG. 8 includes multiple levels of hierarchy. Referring to FIG. 8, an exemplary time usage model having 4 levels of hierarchy is illustrated. The level 4 may be the total time 802 a machine available at the worksites 102. At level 3, the total time 802 is divided into the available time 804 of the machine and the down time 806 of the machine at the worksite 102. At level 2, the available time 804 includes the delay time 808. Subsequently, at level 1, the delay time 808 is divided into the operating delay 810 and the non-operating time 812. The available time 804 at the level 3 is further categorized in to the operating time 814 and the standby 816. The down time 806 at level 3 may be further classified into scheduled down time 818 and unscheduled down time 820. The activities and time delay events of the worksites 102 may be listed as attributes of time categories of the level 1.

An exemplary time usage model 404 is described below. It may be noted that the events and activities listed under various levels are exemplary. The operating time 814 of the available time 804 may include events such as loading. Typically, productive time is defined as operating time. The delays are represented under delay time, down time and standby based on the delay caused to the machine. The operating delay 810 may be a level 1 component of the delay time 808 of the available time 804. An event under the operating delay 810 may be a clean up roadway. The level 1 and level 2 components of the down time 806 may be scheduled down 818 and unscheduled down 820. The non operating time 812 may include an event called shift change. The standby 816 may be level 1 and level 2 component of the available time 804. The standby 816 includes an event of scheduled off shift. The scheduled down time 818 includes activities such as, but not limited to, scheduled mechanical, scheduled electrical and scheduled autonomy specific. Similarly, the unscheduled down time 820 of the down time 806 includes activities, such as base machine break-down and autonomy specific breakdown.

It is to be understood that individual features, information accessing system 202, data management system 204, and the likes shown or described in one embodiment of the present disclosure may be combined with individual features shown or described in another embodiment of the present disclosure. The above described implementation does not in any way limit the scope of the present disclosure. Therefore, it is to be understood that although some features are shown or described to illustrate the use of the present disclosure in the context of functional segments such as various modules of present disclosure, such features may be omitted from the scope of the present disclosure without departing from the scope of the present disclosure as defined in the appended claims.

### INDUSTRIAL APPLICABILITY

The present disclosure relates to the system 200 and a method 900 for managing data of the worksites 102 with high integrity. The data warehouse 306 according to the present disclosure stores the data for future access. Moreover, the information stored in the data warehouse 306 may be updated based on inputs of the first and second source systems 106, 108. The data virtualization module 304 of the system 200 according to the present disclosure regulates the updated data for keeping the data warehouse 306 consistent with the first and second source systems 106, 108. The data consolidation module 314 in the data virtualization module 304 is configured to provide a consistent terminology and units for the data extracted from the first and second source systems 106, 108. Thus, the information accessing system 202 becomes a platform for accessing information and generating reports of the worksites 102. The time usage model 404 enables tracking of time invested in various events and activities and may be utilized in productivity calculations for availability, utilization and equipment utilization. The corporate warehouse 212 of the information accessing system 202 enables to generate the multisite comparison reports, which provides understanding of the worksites 102 at multiple locations.

The system 200 may be embodied as a computer program product in a computer. The computer program product is enabled to generate reports of the first and second source systems 106, 108 associated with the worksites 102.

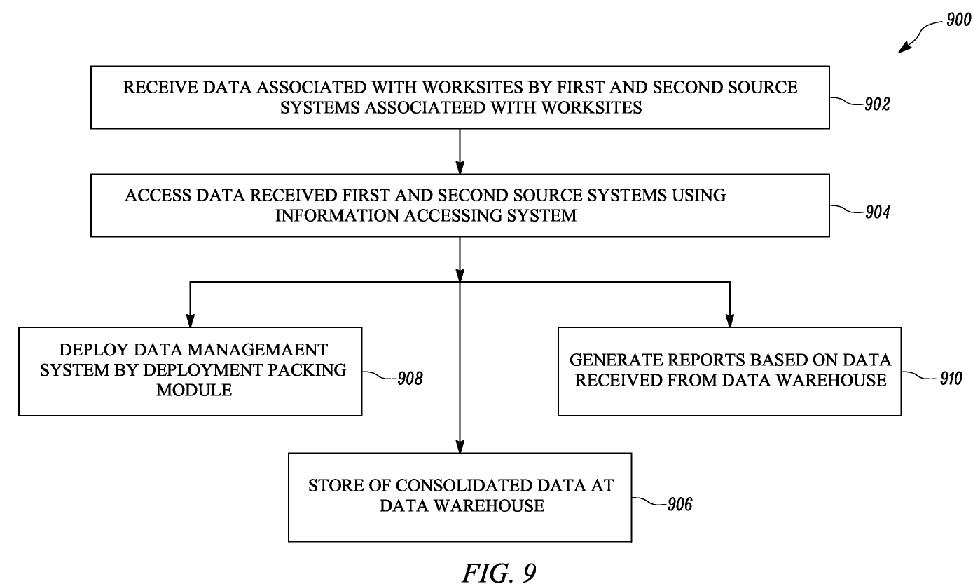

FIG. 9 illustrates a flowchart of the method 900 of managing data associated with the worksites 102, according to an embodiment of present disclosure. At step 902, the method 900 includes receiving the data associated with the worksites by the first and second source systems 106,108 associated with the worksites 102. The first and second source systems 106, 108 may obtain the data associated with the worksites 102 and stores at the corresponding databases. The information accessing system 202 is communicated with the first and second source systems 106, 108.

At step 904, the method 900 includes accessing the data received in the first and second source systems 106,108 using the information accessing system 202. In order to provide access to the data associated with the worksites 102, the information system extracts the data from the first and second source system 106, 108 and manages the extracted data using the data management system 204. The data management system 204 of the information accessing system 202 includes the data capturing module 302 for extracting the data from the one or more source systems 106,108. The extracted data is formatted by the data virtualization module 304. The data virtualization module 304 includes the data identification module 308 for identifying a format of the extracted data based on a version of the first and second source systems 106,108, a database of the first and second source systems 106,108, and the reporting tool 207. Further, the standardization module 310 of the data virtualization module 304 determines a plurality of pre-defined standards associated with the extracted data. The data virtualization module 304 further includes the transformation module 312 for transforming the identified format of the extracted data based on the plurality of pre-defined standards. The data transformed by the transformation module 312 is consolidated by the data consolidation module 314.

At step 906, the method 900 further includes storing of the consolidated data at the data warehouse 306. The stored data may be used for generating reporting using the reporting server 206. The reporting server 206 also includes the reporting tool 207 for generating reports of the one or more worksite 102 from the data warehouse 306.

At step 908, the method 900 further includes deploying the data management system 204 by the deployment packaging module 208. The step 906 of deploying the data management system 204 includes the following process. Primarily, a plurality of pre-defined supporting instructions for deployment of the data management system 204 is provided by the source system support module 502 to the information access system 202. Thereupon, a set of pre-defined transformation logic to be executed during configuration of the data management system 204 is scheduled. Further, the data management system 204 is configured in the information accessing system 202 by the configuration module 504 based on the plurality of pre-defined supporting instructions.

At step 908, the method 900 further includes generate one or more reports based on the data received from the data warehouse 306 located at each of multiple worksites by the corporate warehouse 212. The corporate warehouse 212 is enabled to generate multisite comparison report of the one or more worksites 102 by the corporate warehouse 212 and report of the data warehouse 306 of the data management system 204 using one or more third party reporting tools. The multisite comparison report and the report generated using the one or more third party reporting tools are stored in the storage module 706 of the corporate warehouse 212.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for managing data associated with one or more worksites, the system comprising:
one or more source systems associated with the one or more worksites for receiving the data associated with the one or more worksites; and
an information accessing system in communication with the one or more source systems, the information accessing system comprising:
a data management system, comprising:
a data capturing module configured to extract the data from the one or more source systems;
a data virtualization module, comprising:
a data identification module for identifying a format of the extracted data based on a version of the one or more source systems, a database of the one or more source systems, and a reporting tool;
a standardization module for determining a plurality of pre-defined standards associated with the extracted data;
a transformation module for transforming the identified format of the extracted data based on the plurality of pre-defined standards; and
a data consolidation module for consolidating the data transformed by the transformation module; and
a data warehouse in communication with the data virtualization module for storing the consolidated data.

2. The system of claim 1, wherein the information accessing system comprises a deployment packaging module for deploying the data management system.

3. The system of claim 2, wherein the deployment packaging module comprises:
a source system support module for providing a plurality of pre-defined supporting instructions for deployment of the data management system;
a configuration module for configuring the data management system based on the plurality of pre-defined supporting instructions;
a scheduling module for scheduling a set of pre-defined transformation logic to be executed during configuration of the data management system; and
a schema of the data management system to be deployed.

4. The system of claim 1, wherein the information accessing system comprises a corporate warehouse, and wherein the corporate warehouse is configured to:
receive the data stored at the data warehouse located at each of multiple worksites; and
generate one or more reports based on the data received from the data warehouse located at each of multiple worksites.

5. The system of claim 4, wherein the corporate warehouse comprises:
a comparison module for generating multisite comparison reports of the one or more worksites;
a report generation module for generating a report using one or more third party reporting tools; and
a storage module for storing the multisite comparison reports and the report generated using the one or more third party reporting tools.

6. The system of claim 1, wherein the information access system comprises a reporting server, and wherein the reporting server comprises the reporting tool for generating reports of the one or more worksites from the data warehouse.

7. The system of claim 1, wherein the data warehouse comprises
a fact table generated based on the consolidated data; and
multiple dimension table, wherein at least one of the multiple dimension tables is a time usage model used for generating time reports of the one or more worksites.

8. The system of claim 1, wherein the extracted data related to the one or more worksites comprises at least one of production information, machine information, operator information, machine time line data, production recording data, a set of pre-defined rules, a plurality of pre-defined parameters, and a combination thereof.

9. A method of managing data associated with one or more worksites, the method comprising:
receiving the data associated with the one or more worksites by one or more source systems;
accessing the data received in the one or more source systems using an information accessing system;
extracting the data from the one or more source systems; and
formatting the extracted data by a data virtualization module, wherein formatting the extracted data further comprises:
identifying a format of the extracted data based on a version of the one or more source systems, a database of the one or more source systems, and a reporting tool;
determining a plurality of pre-defined standards associated with the extracted data;
transforming the identified format of the extracted data based on the plurality of pre-defined standards; and
consolidating the data transformed by the transformation module; and
storing the consolidated data in a data warehouse.

10. The method of claim 9 further comprising:
deploying a data management system by a deployment packaging module, wherein deploying the data management system further comprises:
providing a plurality of pre-defined supporting instructions for deployment of the data management system;
configuring the data management system based on the plurality of pre-defined supporting instructions; and
scheduling a set of pre-defined transformation logic to be executed during configuration of the data management system.

11. The method of claim 9, wherein accessing the data further comprises:
generating multisite comparison reports of the one or more worksites by a corporate warehouse;
generating a report using one or more third party reporting tools; and
storing the multisite comparison reports and the report generated using the one or more third party reporting tools.

12. The method of claim 9 further comprising, generating reports from the data warehouse using the reporting tool of the reporting server.

13. The method of claim 9, wherein the data warehouse comprises:
a fact table generated based on the consolidated data; and
multiple dimension table, wherein at least one of the multiple dimension tables is a time usage model used for generating time reports of the one or more worksites.

14. The method of claim 9, wherein the extracted data related to the one or more worksites comprises at least one of production information, machine information, operator information, machine time line data, production recording data, a set of pre-defined rules, a plurality of pre-defined parameters, and a combination thereof.

15. A computer program product embodied in a computer for managing data associated with one or more worksites, the computer program product causing the computer to perform operations comprising:
receiving the data associated with the one or more worksites by one or more source systems;
accessing the data received in the one or more source systems using an information accessing system;
extracting the data from the one or more source systems; and
formatting the extracted data by a data virtualization module, wherein formatting the extracted data further comprises:
identifying a format of the extracted data based on a version of the one or more source systems, a database of the one or more source systems, and a reporting tool;
determining a plurality of pre-defined standards associated with the extracted data;
transforming the identified format of the extracted data based on the plurality of pre-defined standards; and
consolidating the data transformed by the transformation module; and
storing the consolidated data in a data warehouse.

16. The computer program product of claim 15, further comprising:
deploying a data management system by a deployment packaging module, wherein deploying the data management system further comprises:
providing a plurality of pre-defined supporting instructions for deployment of the data management system;
configuring the data management system based on the plurality of pre-defined supporting instructions; and
scheduling a set of pre-defined transformation logic to be executed during configuration of the data management system.

17. The computer program product of claim 15, wherein accessing to the data further comprises:
generating multisite comparison reports of the one or more worksites by a corporate warehouse;
generating a report using one or more third party reporting tools; and
storing the multisite comparison reports and the report generated using the one or more third party reporting tools.

18. The computer program product of claim 15, further comprising:
generating reports from the data warehouse using the reporting tool of the reporting server.

19. The computer program product of claim 18, wherein the data warehouse comprises:
a fact table, wherein the fact table is generated based on the consolidated data; and
multiple dimension table, wherein at least one of the multiple dimension tables is a time usage model for generating time reports of the one or more worksite.

20. The computer program product of claim 15, wherein the extracted data related to the one or more worksites comprises at least one of production information, machine information, operator information, machine time line data, production recording data, a set of pre-defined rules, a plurality of pre-defined parameters, and a combination thereof.
